(19) United States
(12) Patent Application Publication
(10) Pub. No.: US 2026/0001522 A1
(43) Pub. Date: Jan. 1, 2026

(54) Emergency Valve

(71) Applicant: CRRC QIQIHAR ROLLING STOCK CO., LTD., Qiqihar, Heilongjiang (CN)

(72) Inventors: Yi Xu, Qiqihar, Heilongjiang (CN); Xiaobin Han, Qiqihar, Heilongjiang (CN); Mingdong Wang, Qiqihar, Heilongjiang (CN)

(21) Appl. No.: 18/844,713

(22) PCT Filed: Jun. 7, 2023
(86) PCT No.: PCT/CN2023/098990

§ 371 Date: May 2, 2025

(30) Foreign Application Priority Data
May 13, 2022 (CN) 202210521016.1

(51) Int. Cl. B60T 15/50; B60T 13/68; B60T 15/18

(52) U.S. Cl. CPC B60T 15/50; B60T 13/68; B60T 15/184

(57) ABSTRACT

The present disclosure provides an emergency valve, including: a valve body (10) comprising an emergency cavity (11), a pressure increasing cavity (12) and an inflation cavity (13) which are spaced apart from one another, wherein an extension direction of the pressure increasing cavity (12) is the same as an extension direction of the inflation cavity (13); an air inlet of the emergency cavity (11) is in communication with a train pipe (71); the pressure increasing cavity (12) is provided with a first communication port, a second communication port and a relief port; the relief port of the pressure increasing cavity (12) is located between the first communication port of the pressure increasing cavity (12) and the second communication port of the pressure increasing cavity (12); the first communication port of the pressure increasing cavity (12) is in communication with a brake cylinder (72); and the second communication port of the pressure increasing cavity (12) is in communication with the emergency cavity (11). The device increases the inflation speed of the train pipe, and achieves the aim of saving energy by utilizing the pressurized air in the brake cylinder.

The present disclosure claims priority to Patent Disclosure No. 202210521016.1, entitled “EMERGENCY VALVE” filed with the National Intellectual Property Administration of P. R. China on May 13, 2022.

### TECHNICAL FIELD

The present disclosure relates to the technical field of railway wagons, specifically to an emergency valve.

### BACKGROUND

A brake system of a railway wagon is composed of an air control valve, an auxiliary air cylinder, an accelerated relief air cylinder, a brake cylinder, and the like, wherein the air control valve is a core control component for a brake system of a vehicle, and controls the brake system of the vehicle to generate braking, relief, and the like. When a train encounters an unexpected dangerous condition, emergency braking needs to be activated.

In related technologies, an air control valve is composed of a main valve, a semi-automatic relief valve, an emergency valve and an intermediate, wherein the emergency valve works under an emergency braking condition and is used for quickly emptying the pressurized air in a train pipe during emergency braking, thereby increasing the emergency braking response speed to enable the train to quickly obtain a relatively large brake force under the emergency braking condition. When the train is relieved after emergency braking, the train pipes and air cylinders of the entire train need to be inflated to the specified pressure before the train can operate again.

However, the performance of the emergency valve in related technologies cannot meet usage requirements.

### SUMMARY

The present disclosure provides an emergency valve to solve the problem that the performance of an emergency valve in related technologies cannot meet usage requirements.

The present disclosure provides an emergency valve. The emergency valve includes: a valve body including an emergency cavity, a pressure increasing cavity and an inflation cavity which are spaced apart from one another, wherein an extension direction of the pressure increasing cavity is the same as an extension direction of the inflation cavity, an air inlet of the emergency cavity is in communication with a train pipe, the pressure increasing cavity is provided with a first communication port, a second communication port and a relief port, the relief port of the pressure increasing cavity is located between the first communication port of the pressure increasing cavity and the second communication port of the pressure increasing cavity, the first communication port of the pressure increasing cavity is in communication with a brake cylinder, the second communication port of the pressure increasing cavity is in communication with the emergency cavity, the relief port of the pressure increasing cavity is in communication with an accelerated relief air cylinder, a valve sleeve is arranged in the inflation cavity, and an outer side wall of the valve sleeve is attached to a cavity wall of the inflation cavity and divides the inflation cavity into a driving cavity and a non-return cavity; a pressure increasing valve core movably arranged in the pressure increasing cavity, wherein an outer side wall of the pressure increasing valve core is attached to an inner side wall of the pressure increasing cavity, the first communication port of the pressure increasing cavity and the second communication port of the pressure increasing cavity respectively correspond to both ends of the pressure increasing valve core, the pressure increasing valve core is provided with a vent hole, a first end of the vent hole is in communication with the first communication port of the pressure increasing cavity, a second end of the vent hole penetrates through a side wall of the pressure increasing valve core, the pressure increasing valve core has a communication position and a pressure maintaining position, when the pressure increasing valve core is located in the communication position, the second end of the vent hole is in communication with the relief port of the pressure increasing cavity, and when the pressure increasing valve core is located in the pressure maintaining position, the second end of the vent hole is isolated from the relief port of the pressure increasing cavity; and an inflation valve core including a first valve core and a second valve core, wherein the first valve core is movably arranged in the driving cavity and divides the driving cavity into a first driving cavity and a second driving cavity, an air outlet of the first driving cavity is in communication with the emergency cavity, the second driving cavity is in communication with an emergency chamber, the second valve core is movably arranged at an air outlet of the non-return cavity, an air inlet of the non-return cavity is in communication with the brake cylinder, the air outlet of the non-return cavity is in communication with an air inlet of the first driving cavity, an end of the first valve core is movably arranged in the valve sleeve, and the first valve core has an inflation position for pushing the second valve core away from an air outlet of the inflation cavity and a blocking position for releasing the second valve core, wherein the valve body is further provided with a communication passage, the second communication port of the pressure increasing cavity is in communication with the emergency cavity through the communication passage, and the air outlet of the first driving cavity is in communication with the emergency cavity through the communication passage.

Further, the communication passage includes a first passage and a second passage which are arranged in an intersected manner, an air inlet of the first passage is in communication with the emergency cavity, a first air outlet of the first passage is in communication with an air inlet of the second passage, a first air outlet of the second passage is in communication with the first driving cavity, and a second air outlet of the second passage is in communication with the second communication port of the pressure increasing cavity.

Further, the pressure increasing cavity and the inflation cavity are respectively located on both sides of the emergency cavity, the second passage has a strip-shaped structure, the air inlet of the second passage is arranged in a middle of the second passage, and the first air outlet of the second passage and the second air outlet of the second passage are respectively arranged at both ends of the second passage.

Further, the valve body includes a valve main body and a first valve cover covered at an end of the valve main body, the emergency cavity, the pressure increasing cavity and the inflation cavity are all arranged on the valve main body, and the first passage and the second passage are both arranged on the first valve cover.

Further, the valve body further includes a relief passage, a first end of the relief passage is in communication with the relief port of the pressure increasing cavity, and a second end of the relief passage is in communication with the accelerated relief air cylinder; the valve body further includes an emergency passage, a first end of the emergency passage is in communication with the emergency chamber, and a second end of the emergency passage is in communication with the second driving cavity; and the valve body further includes an air inlet passage, a first end of the air inlet passage is in communication with the brake cylinder, and a second end of the air inlet passage is in communication with the air inlet of the non-return cavity, wherein the second end of the relief passage, the first end of the emergency passage, the second end of the air inlet passage, the air inlet of the emergency cavity and the first communication port of the pressure increasing cavity are all arranged at an end of the valve main body away from the first valve cover.

Further, the valve body further includes a pilot valve cavity and a pilot valve passage, an air inlet of the pilot valve passage is in communication with a second air outlet of the first passage, an air outlet of the pilot valve passage is in communication with an air inlet end of the pilot valve cavity, the first passage has a strip-shaped structure, and the first air outlet of the first passage is arranged between the air inlet of the first passage and the second air outlet of the first passage.

Further, the emergency valve further includes a driving assembly, the driving assembly is movably arranged in the emergency cavity, the driving assembly divides the emergency cavity into an emergency upper cavity and an emergency lower cavity, the driving assembly is provided with a transition hole, and the transition hole is in communication with the emergency upper cavity and the emergency lower cavity; the emergency valve further includes a deflation valve assembly, the deflation valve assembly is located in the emergency lower cavity, the driving assembly is located above the deflation valve assembly, a division plate is arranged in the emergency cavity, the division plate divides the emergency lower cavity into an air inlet cavity and an air discharge cavity located below the air inlet cavity, the division plate is provided with a deflation hole, and the deflation valve assembly is movably arranged at the deflation hole; and the emergency valve further includes a pilot valve assembly, the pilot valve assembly is arranged in the pilot valve cavity and isolates the pilot valve cavity from the air discharge cavity, the deflation valve assembly is located above the pilot valve assembly, and the pilot valve assembly is movably arranged at an air outlet end of the pilot valve cavity.

Further, the valve body further includes a second valve cover, the second valve cover is covered above the driving assembly, the driving assembly includes a driving main body and an elastic cap connected with the driving main body, the elastic cap is clamped between the valve main body and the second valve cover and divides the emergency cavity into an emergency upper cavity and an emergency lower cavity, and the transition hole is arranged on the driving main body; and/or the valve body further includes a third valve cover, and the pilot valve cavity is arranged on the third valve cover.

Further, the valve body is further provided with an inflation passage, an air inlet of the inflation passage is in communication with the air outlet of the non-return cavity, an air outlet of the inflation passage is in communication with the air inlet of the first driving cavity, a non-return valve is arranged in the inflation passage, the non-return valve includes a non-return valve core and a return spring, an end of the return spring abuts against the non-return valve core, and the other end of the return spring abuts against the valve body; and the valve body further includes a fourth valve cover connected with the valve main body, the inflation passage includes a first passage, a second passage and a third passage which are in communication sequentially, the first passage and the third passage are arranged on the valve main body, and the second passage is arranged on the fourth valve cover.

Further, both the first passage and the second passage have a strip-shaped structure, and the first passage is perpendicular to the second passage; and/or the first valve core includes a piston cap and a piston rod which are connected to each other, an outer edge of the piston cap is attached to a cavity wall of the driving cavity and divides the driving cavity into the first driving cavity and the second driving cavity, and an end of the piston rod is arranged corresponding to the second valve core.

By applying the technical solution of the present disclosure, during emergency braking of a train, the train pipe empties the pressurized air, and the pressure increasing cavity which is in communication with the emergency cavity empties the pressurized air through the first communication port of the emergency cavity, so that the pressure at the second communication port of the pressure increasing cavity which is in communication with the brake cylinder is greater than the pressure at the first communication port of the pressure increasing cavity. As a result, the pressure increasing valve core moves to the first communication port of the pressure increasing cavity along an axis of the pressure increasing cavity to enable the pressure increasing valve core to be located at one end of the pressure increasing cavity close to the first communication port, so that the second end of the vent hole of the pressure increasing valve core is in communication with the relief port of the pressure increasing cavity. At this time, the brake cylinder is in communication with the accelerated relief air cylinder through the vent hole, so that the pressurized air in the accelerated relief air cylinder can be filled into the brake cylinder. Because compared to normal braking, the air pressure in the brake cylinder increases, the brake force of the brake cylinder can be increased. When the train is relieved after emergency braking, the train pipe is inflated. The first driving cavity is in communication with the train pipe through the emergency cavity, the second driving cavity is in communication with the emergency chamber, and the inflation speed of the first driving cavity is greater than the inflation speed of the second driving cavity, so that the pressure of the first driving cavity is greater than the pressure of the second driving cavity. Under the drive of the pressure difference, the first valve core pushes the second valve core away from the air outlet of the inflation cavity, so that the inflation cavity is in communication with the first driving cavity. As a result, the pressurized air in the brake cylinder enters the emergency cavity through the inflation cavity and the first driving cavity and is filled into the train pipe through the emergency cavity, thereby accelerating the inflation speed of the train pipe. Moreover, the purpose of saving energy sources is achieved by using the pressurized air in the brake cylinder.

### BRIEF DESCRIPTION OF THE DRAWINGS

The accompanying drawings of the specification, constituting a part of the present disclosure, are used for providing a further understanding of the present disclosure. The exemplary embodiments of the present disclosure and the descriptions thereof are used for explaining the present disclosure, and do not constitute an improper limitation on the present disclosure. In the accompanying drawings:

FIG. 1 shows a cross-sectional view of an emergency valve provided in an embodiment of the present disclosure;

FIG. 2 shows a cross-sectional view of an emergency cavity provided in an embodiment of the present disclosure;

FIG. 3 shows a side view of an emergency valve provided in an embodiment of the present disclosure;

FIG. 4 shows a top view of an emergency valve provided in an embodiment of the present disclosure;

FIG. 5 shows a cross-sectional view of a pressure increasing cavity provided in an embodiment of the present disclosure;

FIG. 6 shows a schematic diagram when a pressure increasing valve core of an emergency valve provided in an embodiment of the present disclosure is located in a pressure maintaining position;

FIG. 7 shows a schematic diagram when a pressure increasing valve core of an emergency valve provided in an embodiment of the present disclosure is located in a communication position;

FIG. 8 shows a cross-sectional view when a first valve core of an emergency valve provided in an embodiment of the present disclosure is located in a blocking position;

FIG. 9 shows a schematic diagram when a first valve core of an emergency valve provided in an embodiment of the present disclosure is located in a blocking position;

FIG. 10 shows a schematic diagram when a first valve core of an emergency valve provided in an embodiment of the present disclosure is located in an inflation position; and

FIG. 11 shows a cross-sectional view of an inflation passage of an emergency valve provided in an embodiment of the present disclosure.

The above accompanying drawings have the following reference numerals:
10. valve body; 11. emergency cavity; 111. emergency upper cavity; 112. emergency lower cavity; 1121. air inlet cavity; 1122. air discharge cavity; 113. division plate; 1131. deflation hole; 12. pressure increasing cavity; 13. inflation cavity; 131. valve sleeve; 132. driving cavity; 1321. first driving cavity; 1322. second driving cavity; 133. non-return cavity; 14. communication passage; 141. first passage; 142. second passage; 15. valve main body; 151. relief passage; 152. emergency passage; 153. inflation passage; 154. non-return valve; 1541. non-return valve core; 1542. return spring; 16. first valve cover; 17. pilot valve cavity; 171. pilot valve passage; 18. second valve cover; 19. third valve cover; 191. fourth valve cover;
20. pressure increasing valve core; 21. vent hole;
30. inflation valve core; 31. first valve core; 311. piston cap; 312. piston rod; 32. second valve core;
40. driving assembly; 41. transition hole; 42. driving main body; 43. elastic cap;
50. deflation valve assembly;
60. pilot valve assembly;
71. train pipe; 72. brake cylinder; 73. accelerated relief air cylinder; 74. emergency chamber.

### DETAILED DESCRIPTION OF THE EMBODIMENTS

The technical solutions in the embodiments of the present disclosure are clearly and completely described below with reference to the accompanying drawings in the embodiments of the present disclosure. Apparently, the described embodiments are only some embodiments rather than all the embodiments of the present disclosure. The following description of at least one exemplary embodiment is actually only illustrative, and does not constitute any limitation on the present disclosure and the disclosure or use of the present disclosure. All other embodiments obtained by those of ordinary skill in the art based on the embodiments in the present disclosure without creative efforts shall fall within the protection scope of the present disclosure.

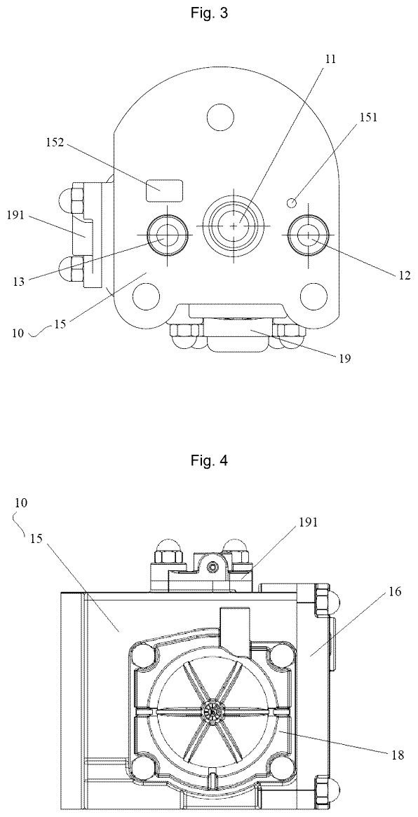

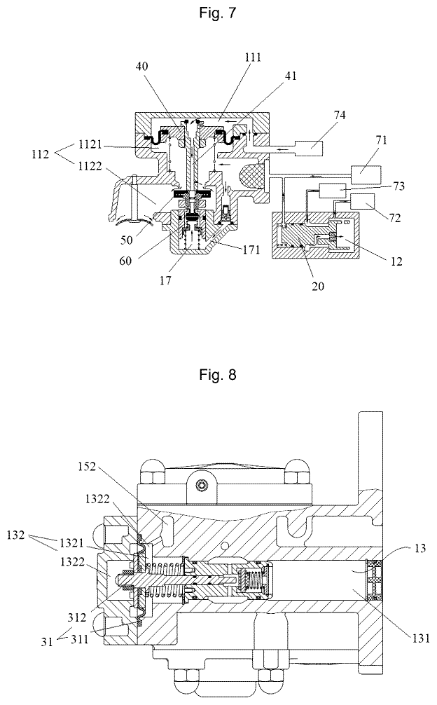

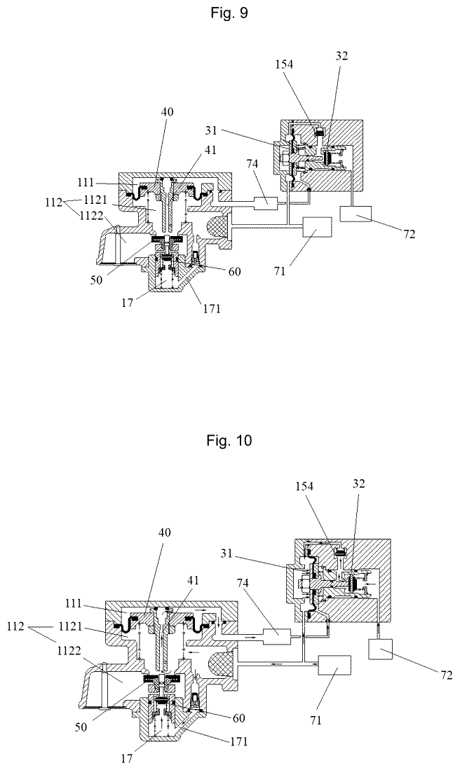

As shown in FIG. 1 to FIG. 11, an embodiment of the present disclosure provides an emergency valve. The emergency valve includes a valve body 10, a pressure increasing valve core 20 and an inflation valve core 30. The valve body 10 includes an emergency cavity 11, a pressure increasing cavity 12 and an inflation cavity 13 which are spaced apart from one another. An extension direction of the pressure increasing cavity 12 is the same as an extension direction of the inflation cavity 13. An air inlet of the emergency cavity 11 is in communication with a train pipe 71. The pressure increasing cavity 12 is provided with a first communication port, a second communication port and a relief port. The relief port of the pressure increasing cavity 12 is located between the first communication port of the pressure increasing cavity 12 and the second communication port of the pressure increasing cavity 12. The first communication port of the pressure increasing cavity 12 is in communication with a brake cylinder 72. The second communication port of the pressure increasing cavity 12 is in communication with the emergency cavity 11. The relief port of the pressure increasing cavity 12 is in communication with an accelerated relief air cylinder 73. A valve sleeve 131 is arranged in the inflation cavity 13. An outer side wall of the valve sleeve 131 is attached to a cavity wall of the inflation cavity 13 and divides the inflation cavity 13 into a driving cavity 132 and a non-return cavity 133. The pressure increasing valve core 20 is movably arranged in the pressure increasing cavity 12. An outer side wall of the pressure increasing valve core 20 is attached to an inner side wall of the pressure increasing cavity 12. The first communication port of the pressure increasing cavity 12 and the second communication port of the pressure increasing cavity 12 respectively correspond to both ends of the pressure increasing valve core 20. The pressure increasing valve core 20 is provided with a vent hole 21. A first end of the vent hole 21 is in communication with the first communication port of the pressure increasing cavity 12. A second end of the vent hole 21 penetrates through a side wall of the pressure increasing valve core 20. The pressure increasing valve core 20 has a communication position and a pressure maintaining position. When the pressure increasing valve core 20 is located in the communication position, the second end of the vent hole 21 is in communication with the relief port of the pressure increasing cavity 12. When the pressure increasing valve core 20 is located in the pressure maintaining position, the second end of the vent hole 21 is isolated from the relief port of the pressure increasing cavity 12. The inflation valve core 30 includes a first valve core 31 and a second valve core 32. The first valve core 31 is movably arranged in the driving cavity 132 and divides the driving cavity 132 into a first driving cavity 1321 and a second driving cavity 1322. An air outlet of the first driving cavity 1321 is in communication with the emergency cavity 11. The second driving cavity 1322 is in communication with an emergency chamber. The second valve core 32 is movably arranged at an air outlet of the non-return cavity 133. An air inlet of the non-return cavity 133 is in communication with the brake cylinder 72. The air outlet of the non-return cavity 133 is in communication with an air inlet of the first driving cavity 1321. An end of the first valve core 31 is movably arranged in the valve sleeve 131. The first valve core 31 has an inflation position for pushing the second valve core 32 away from an air outlet of the inflation cavity 13 and a blocking position for releasing the second valve core 32. The valve body 10 is further provided with a communication passage 14. The second communication port of the pressure increasing cavity 12 is in communication with the emergency cavity 11 through the communication passage 14. The air outlet of the first driving cavity 1321 is in communication with the emergency cavity 11 through the communication passage 14.

By applying the technical solution of the present disclosure, during emergency braking of a train, the train pipe 71 empties the pressurized air, and the pressure increasing cavity 12 which is in communication with the emergency cavity 11 empties the pressurized air through the first communication port, so that the pressure at the second communication port of the pressure increasing cavity 12 which is in communication with the brake cylinder 72 is greater than the pressure at the first communication port of the pressure increasing cavity 12. As a result, the pressure increasing valve core 20 moves to the first communication port of the pressure increasing cavity 12 along an axis of the pressure increasing cavity 12 to enable the pressure increasing valve core 20 to be located at an end of the pressure increasing cavity 12 close to the first communication port, so that the second end of the vent hole 21 on the pressure increasing valve core 20 is in communication with the relief port of the pressure increasing cavity 12. At this time, the brake cylinder 72 is in communication with the accelerated relief air cylinder 73 through the vent hole 21, so that the pressurized air in the accelerated relief air cylinder 73 can be filled into the brake cylinder 72. Because compared to normal braking, the air pressure in the brake cylinder 72 increases, the brake force of the brake cylinder 72 can be increased. When the train is relieved after emergency braking, the train pipe 71 is inflated. The first driving cavity 1321 is in communication with the train pipe 71 through the emergency cavity 11, the second driving cavity 1322 is in communication with the emergency chamber 74, and the inflation speed of the first driving cavity 1321 is greater than the inflation speed of the second driving cavity 1322, so that the pressure of the first driving cavity 1321 is greater than the pressure of the second driving cavity 1322. Under the drive of the pressure difference, the first valve core 31 pushes the second valve core 32 away from the air outlet of the inflation cavity 13, so that the inflation cavity 13 is in communication with the first driving cavity 1321. As a result, the pressurized air in the brake cylinder 72 enters the emergency cavity 11 through the inflation cavity 13 and the first driving cavity 1321 and is filled into the train pipe 71 through the emergency cavity 11, thereby accelerating the inflation speed of the train pipe 71. Moreover, the purpose of saving energy sources is achieved by using the pressurized air in the brake cylinder 72.

It should be noted that in related technologies, when the train is relieved after emergency braking, air can only be supplied to each of the trains through the train pipe 71. However, since a large amount of pressurized air used by emergency braking needs to be replenished, it takes a long time, which not only affects the efficiency of railway transportation, but also consumes a lot of energy sources. Moreover, although quick braking under emergency conditions can be achieved when the emergency valve is emptied, during normal braking and emergency braking, air is filled into the brake cylinder 72 through an auxiliary air cylinder, and the brake force during emergency braking does not increase compared to the brake force under normal braking conditions, so that it is difficult to better achieve emergency stop within a short distance. In the present disclosure, by arranging the pressure increasing valve core 20 in the valve body 10, the pressurized air in the accelerated relief air cylinder 73 can be filled into the brake cylinder 72. Because compared to normal braking, the air pressure in the brake cylinder 72 increases, the brake force of the brake cylinder 72 can be increased. By arranging the inflation valve core 30 in the valve body 10, the pressurized air in the brake cylinder 72 is filled into the train pipe 71 through the emergency cavity 11, thereby accelerating the inflation speed of the train pipe 71. Moreover, the purpose of saving energy sources is achieved by using the pressurized air in the brake cylinder 72.

In this embodiment, a non-return valve 154 is arranged between the air inlet of the first driving cavity 1321 and the air outlet of the inflation cavity 13. During the first inflation of the train, due to the absence of the pressurized air in a brake system, the inflation speed of the first driving cavity 1321 is greater than the inflation speed of the second driving cavity 1322, and under the drive of the pressure difference, the first valve core 31 pushes the second valve core 32 away from the air outlet of the inflation cavity 13. However, due to the absence of the pressurized air in the brake cylinder 72, during the first inflation, the brake cylinder 72 will not inflate the train pipe 71. Moreover, due to the arrangement of the non-return valve 154, the pressurized air in the train pipe 71 can be prevented from being directly filled into the brake cylinder 72 through the first driving cavity 1321. However, when the train is relieved after emergency braking, the air pressure in the brake cylinder 72 is greater than the air pressure in the first driving cavity 1321, and the pressurized air in the brake cylinder 72 can pass through the inflation cavity 13 and open the non-return valve 154 by rushing, thereby inflating the train pipe 71 through the first driving cavity 1321.

The first valve core 31 includes a first valve core spring. During the conditions of normal braking, relief after normal braking and emergency braking, because the resultant force of the air pressure in the second driving cavity 1322 and the elastic force of the first valve core spring is greater than the air pressure in the first driving cavity 1321, the first valve core 31 is located in the blocking position for releasing the second valve core 32, and the inflation cavity 13 is in non-communication with the first driving cavity 1321. Therefore, the pressurized air in the brake cylinder 72 can not be filled into the train pipe 71.

It should be noted that an end of the pressure increasing valve core 20 close to the first communication port of the pressure increasing cavity 12 is also provided with a pressure increasing valve core spring. During emergency braking of the train, because the pressure increasing valve core 20 moves to the first communication port of the pressure increasing cavity 12, the pressure increasing valve core spring is in a compressed state. When the train needs to be relieved after emergency braking, the resultant force of the air pressure in the pressure increasing valve core spring and the train pipe 71 is greater than the air pressure in the brake cylinder 72, so that the pressure increasing valve core 20 can be quickly reset.

In this embodiment, when the inflation of the train pipe 71 is completed, during the conditions of normal braking, relief after normal braking and relief after emergency braking, the resultant force of the pressure at the first communication port of the pressure increasing cavity 12 and the elastic force of the pressure increasing valve core spring is greater than the pressure at the second communication port of the pressure increasing cavity 12, so that the pressure increasing valve core 20 moves to the second communication port of the pressure increasing cavity 12. Finally, the pressure increasing valve core 20 is located at the end of the pressure increasing cavity 12 close to the second communication port, so that the second end of the vent hole 21 of the pressure increasing valve core 20 and the relief port of the pressure increasing cavity 12 are in a closed state. Therefore, the brake cylinder 72 is in non-communication with the accelerated relief air cylinder 73, and the brake cylinder 72 is in a pressure maintaining state.

It should be noted that during normal braking of the train, air is filled into the brake cylinder 72 only through an auxiliary air cylinder. However, during the emergency braking condition, the pressurized air in both the train pipe 71 and the emergency chamber 74 is discharged into the atmosphere. The accelerated relief air cylinder 73 is in communication with the brake cylinder 72 through the vent hole 21, so that the air pressure received by the brake cylinder 72 is derived from the auxiliary air cylinder as well as the accelerated relief air cylinder 73 to solve the problem that the brake force during emergency braking does not increase compared to the brake force during normal braking.

Specifically, during the inflation stage of the train pipe 71 until the inflation is completed, the accelerated relief air cylinder 73 is in communication with the train pipe 71 until the air pressure in the train pipe 71 is about 500 KP, and the pressure is greater than the air pressure in the brake cylinder 72. As a result, when the brake cylinder 72 is in communication with the accelerated relief air cylinder 73, the effect of inflation from the accelerated relief air cylinder 73 to the brake cylinder 72 can be achieved.

During the emergency braking condition, the pressurized air in both the train pipe 71 and the emergency chamber 74 is discharged into the atmosphere.

In this embodiment, the pressure increasing valve core 20 has a communication position and a pressure maintaining position. The communication position means that the pressure at the second communication port of the pressure increasing cavity 12 is greater than the pressure at the first communication port of the pressure increasing cavity 12, and the pressure increasing valve core 20 moves to the first communication port of the pressure increasing cavity 12, so that the second end of the vent hole 21 on the pressure increasing valve core 20 is in communication with the relief port of the pressure increasing cavity 12. The pressure maintaining position means that the resultant force of the pressure at the first communication port of the pressure increasing cavity 12 and the elastic force of the pressure increasing valve core spring is greater than the pressure at the second communication port of the pressure increasing cavity 12, and the pressure increasing valve core 20 moves to the second communication port of the pressure increasing cavity 12, so that the second end of the vent hole 21 of the pressure increasing valve core 20 is isolated from the relief port of the pressure increasing cavity 12.

It should be noted that the first valve core 31 having an inflation position for pushing the second valve core 32 away from an air outlet of the inflation cavity 13 and a blocking position for releasing the second valve core 32 means that the first valve core 31 is affected by the pressure difference between the first driving cavity 1321 and the second driving cavity 1322; when the train is relieved after emergency braking, the resultant force of the air pressure in the second driving cavity 1322 and the elastic force of the first valve core spring is greater than the air pressure in the first driving cavity 1321, and the first valve core 31 pushes the second valve core 32 away from the air outlet of the inflation cavity 13 and is located in the inflation position; and when there is pressurized air in both the first driving cavity 1321 and the second driving cavity 1322, the air pressure in the first driving cavity 1321 is equal to the air pressure in the second driving cavity 1322, and under the action of the first valve core spring, the first valve core 31 is located in the blocking position for releasing the second valve core 32.

Moreover, by arranging both the pressure increasing valve core 20 and the inflation valve core 30 in the valve body 10, the function of increasing the brake force through emergency braking and the function of saving energy sources through relief after emergency braking are integrated, thereby enhancing the function of the emergency valve while facilitating the miniaturization of the emergency valve.

In this embodiment, the pressure increasing valve core 20 includes a pressure increasing sleeve and a pressure increasing rod movably arranged in the pressure increasing sleeve. An outer side wall of the pressure increasing sleeve is attached to the inner side wall of the pressure increasing cavity 12, the vent hole 21 includes a first hole section and a second hole section which are arranged correspondingly, the first hole section is arranged on the pressure increasing rod, the second hole section penetrates through a side wall of the pressure increasing sleeve, one end of the first hole section is in communication with the second communication port of the pressure increasing cavity 12, the other end of the first hole section penetrates through a side wall of the pressure increasing rod, and one end of the second hole section is in communication with the relief port of the pressure increasing cavity. By using the pressure increasing valve core 20 having the above structure, the pressure increasing rod can be guided by the pressure increasing sleeve, thereby enhancing the accuracy of the pressure increasing valve core 20.

The pressure increasing rod includes a guide section and a limiting section which are connected to each other. The guide section is movably arranged in the pressure increasing sleeve, the limiting section is located at an end of the pressure increasing cavity 12 facing the second communication port of the pressure increasing cavity 12, and an end of the limiting section is matched with the pressure increasing sleeve in a limited manner. The pressure increasing rod can be limited by the limiting section, so that during emergency braking of the train, the first hole section on the pressure increasing rod can be in communication with the second hole section on the pressure increasing sleeve. Moreover, a first constriction plug is arranged on the first hole section. By using the first constriction plug, the inflation speed from the accelerated relief air cylinder 73 to the brake cylinder 72 can be reduced to ensure that the brake force of each of the trains does not differ significantly, thereby avoiding the phenomenon of different driving speeds of each of the trains during emergency braking, and enhancing the consistency of the trains.

In this embodiment, the first valve core 31 includes a piston cap 311 and a piston rod 312 which are connected to each other. An outer edge of the piston cap 311 is attached to a cavity wall of the driving cavity 132 and divides the driving cavity 132 into the first driving cavity 1321 and the second driving cavity 1322, and an end of the piston rod 312 is arranged corresponding to the second valve core 32. By using the first valve core 31 having the above structure, the driving cavity 132 can be divided by the piston cap 311, and the second valve core 32 can be driven by the piston rod 312 to move.

Moreover, a non-return sleeve is also arranged in the valve body 10, both ends of the non-return sleeve have an open structure, the open structure of an end of the non-return sleeve is the air outlet of the non-return cavity, and the second valve core is movably arranged in the non-return sleeve.

Specifically, when the train is relieved after emergency braking, the first valve core 31 moves to the non-return cavity 133 under the action of the driving pressure difference between the first driving cavity 1321 and the second driving cavity 1322, so as to push the second valve core 32 away from the position for closing the non-return sleeve, so that the gas in the brake cylinder 72 can be filled into the first driving cavity 1321.

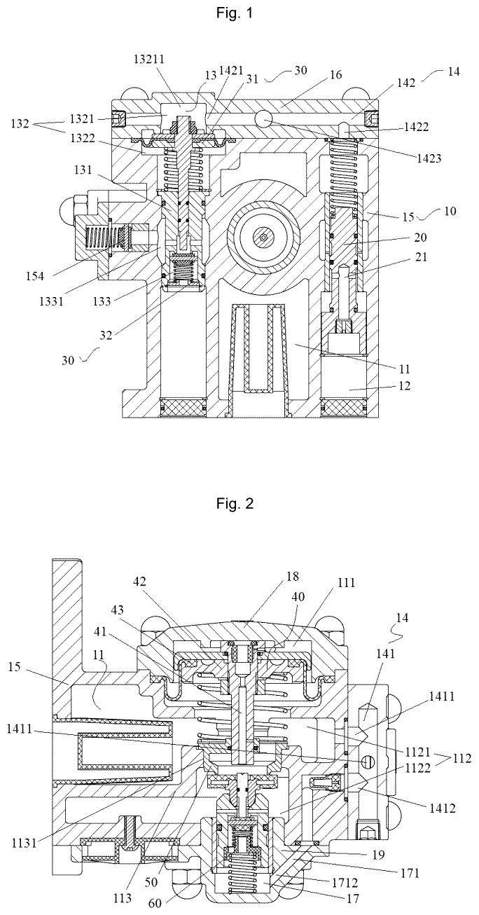

As shown in FIG. 1 and FIG. 2, the communication passage 14 includes a first passage 141 and a second passage 142 which are arranged in an intersected manner, an air inlet of the first passage 141 is in communication with the emergency cavity 11, a first air outlet of the first passage 141 is in communication with an air inlet of the second passage 142, a first air outlet of the second passage 142 is in communication with the first driving cavity 1321, and a second air outlet of the second passage 142 is in communication with the second communication port of the pressure increasing cavity 12. The communication passage 14 having the above structure has the advantages of easy connection and processing.

In this embodiment, the extension direction of the emergency cavity 11 is perpendicular to the extension direction of the pressure increasing cavity 12, and the communication passage 14 having the above structure fully utilizes the space of the valve body 10.

As shown in FIG. 1 and FIG. 2, the pressure increasing cavity 12 and the inflation cavity 13 are respectively located on both sides of the emergency cavity 11, the second passage 142 has a strip-shaped structure, the air inlet of the second passage 142 is arranged in the middle of the second passage 142, and the first air outlet of the second passage 142 and the second air outlet of the second passage 142 are respectively arranged at both ends of the second passage 142. By using the above structure, the emergency valve is miniaturized and also has the advantage of easy processing.

The air inlet of the second passage 142 being arranged in the middle of the second passage 142 means that the air inlet of the second passage 142 is located at a geometric center of the second passage 142.

As shown in FIG. 1 and FIG. 2, the valve body 10 includes a valve main body 15 and a first valve cover 16 covered at an end of the valve main body 15, the emergency cavity 11, the pressure increasing cavity 12 and the inflation cavity 13 are all arranged on the valve main body 15, and the first passage 141 and the second passage 142 are both arranged on the first valve cover 16. By using the valve body 10 having the above structure, utilizing the valve main body 15 to arrange the emergency cavity 11, the pressure increasing cavity 12 and the inflation cavity 13, utilizing the first valve cover 16 to arrange the first passage 141 and the second passage 142, so that the advantages of easy processing and installation are achieved.

In this embodiment, sealing rings are arranged between the first valve cover 16 and the emergency cavity 11 as well as between the first valve cover 16 and the pressure increasing cavity 12, so that the sealing performance of the valve body 10 can be enhanced.

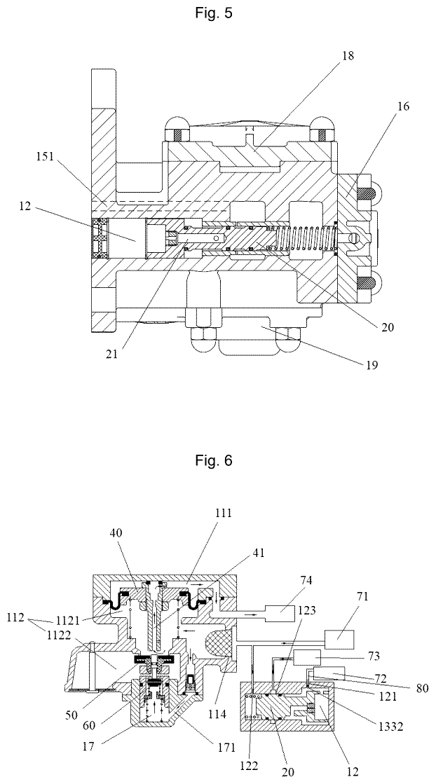

As shown in FIG. 5 to FIG. 7, the valve body 10 further includes a relief passage 151, a first end of the relief passage 151 is in communication with the relief port of the pressure increasing cavity 12, and a second end of the relief passage 151 is in communication with the accelerated relief air cylinder 73. By using the relief passage 151, the advantage of easy connection between the accelerated relief air cylinder 73 and the pressure increasing cavity 12 is achieved.

Specifically, the valve body 10 further includes an emergency passage 152, a first end of the emergency passage 152 is in communication with the emergency chamber 74, and a second end of the emergency passage 152 is in communication with the second driving cavity 1322. By using the emergency passage 152, it is easy to enable the second driving cavity 1322 to be in communication with the emergency chamber 74.

A second constriction plug is arranged on the emergency passage 152, and the second constriction plug is provided with a central hole. By using the second constriction plug, the inflation speed from the emergency chamber 74 to the second driving cavity 1322 can be reduced.

In this embodiment, the valve body 10 further includes an air inlet passage, a first end of the air inlet passage is in communication with the brake cylinder 72, and a second end of the air inlet passage is in communication with the air inlet of the non-return cavity 133. By using the air inlet passage, it is beneficial for the communication between the brake cylinder 72 and the non-return cavity 133.

In this embodiment, the air inlet passage is arranged on the non-return cavity 133.

The second end of the relief passage 151, the first end of the emergency passage 152, the second end of the air inlet passage, the air inlet of the emergency cavity 11 and the first communication port of the pressure increasing cavity 12 are all arranged at an end of the valve main body 15 away from the first valve cover 16. By using the valve main body 15 having the above structure, passage ports of all passages are arranged on a same end surface, so that the advantage of easy connection is achieved, and the miniaturization of the emergency valve is facilitated.

As shown in FIG. 2, the valve body 10 further includes a pilot valve cavity 17 and a pilot valve passage 171, an air inlet of the pilot valve passage 171 is in communication with a second air outlet of the first passage 141, an air outlet of the pilot valve passage 171 is in communication with an air inlet end of the pilot valve cavity 17, the first passage 141 has a strip-shaped structure, and the first air outlet of the first passage 141 is arranged between the air inlet of the first passage 141 and the second air outlet of the first passage 141. By using the pilot valve passage 171, the gas entering the emergency cavity 11 from the train pipe 71 can be filled into the pilot valve cavity 17. Moreover, different functions are achieved respectively by the first air outlet and second air outlet of the first passage 141, and the advantage of simple structure is achieved.

As shown in FIG. 2, the emergency valve further includes a driving assembly 40, the driving assembly 40 is movably arranged in the emergency cavity 11, the driving assembly 40 divides the emergency cavity 11 into an emergency upper cavity 111 and an emergency lower cavity 112, the driving assembly 40 is provided with a transition hole 41, and the transition hole 41 is in communication with the emergency upper cavity 111 and the emergency lower cavity 112. By using the driving assembly 40, the emergency valve can quickly empty the pressurized air in the emergency lower cavity 112, so that quick braking of the train can be achieved.

In this embodiment, the emergency upper cavity 111 can be inflated through the transition hole 41, but the inflation speed of the emergency upper cavity 111 is lower than the inflation speed of the emergency lower cavity 112. Thus, the driving assembly 40 can operate due to the pressure difference between the emergency upper cavity 111 and the emergency lower cavity 112.

Specifically, the emergency valve further includes a deflation valve assembly 50, the deflation valve assembly 50 is located in the emergency lower cavity 112, the driving assembly 40 is located above the deflation valve assembly 50, a division plate 113 is arranged in the emergency cavity 11, the division plate 113 divides the emergency lower cavity 112 into an air inlet cavity 1121 and an air discharge cavity 1122 located below the air inlet cavity 1121, the division plate 113 is provided with a deflation hole 1131, and the deflation valve assembly 50 is movably arranged at the deflation hole 1131. During the emergency braking condition of the train, the driving assembly 40 drives the deflation valve assembly 50 to enable the deflation valve to be located in an open position, so that the emergency valve with an emergency accelerated relief function can quickly empty the pressurized air in the train pipe.

In this embodiment, during the non-emergency braking condition of the train, there is no need to empty the pressurized air in the train pipe 71 through the emergency valve.

The deflation valve assembly 50 includes a deflation valve body and a deflation valve core movably arranged in the deflation valve body, and the deflation valve body is movably arranged at the deflation hole 1131.

It should be noted that the emergency valve further includes a pilot valve assembly 60, the pilot valve assembly 60 is arranged in the pilot valve cavity 17 and isolates the pilot valve cavity 17 from the air discharge cavity 1122, the deflation valve assembly 50 is located above the pilot valve assembly 60, and the pilot valve assembly 60 is movably arranged at an air outlet end of the pilot valve cavity 17. By using the pilot valve assembly 60, it is beneficial for the driving assembly 40 to quickly open the deflation valve assembly 50, thereby accelerating the emptying speed of the emergency valve.

The pilot valve assembly 60 includes a pilot valve body and a pilot valve core movably arranged in the pilot valve body, and the pilot valve core is movably arranged at an air outlet of the pilot valve body.

In this embodiment, during emergency braking of the train, due to the presence of the transition hole 41, the air discharge speed of the air inlet cavity 1121 is greater than the air discharge speed of the emergency upper cavity 111, so that the pressure of the emergency upper cavity 111 is greater than the pressure of the air inlet cavity 1121. As a result, the driving assembly 40 can move downward, the driving assembly 40 abuts against the deflation valve core and drives the deflation valve core to move downward, and the deflation valve core drives the pilot valve core to move downward while moving. Because the pilot valve cavity 17 is in communication with the air inlet cavity 1121 through the first passage 141, the pressure of the pilot valve cavity 17 can be released to reduce the resistance for opening the deflation valve assembly 50. When the driving assembly 40 abuts against the deflation valve body, the deflation valve body can be quickly pushed away from the deflation hole 1131 to enable the emergency valve to discharge air quickly.

As shown in FIG. 2 and FIG. 4, the valve body 10 further includes a second valve cover 18, the second valve cover 18 is covered above the driving assembly 40, the driving assembly 40 includes a driving main body 42 and an elastic cap 43 connected with the driving main body 42, the elastic cap 43 is clamped between the valve main body 15 and the second valve cover 18 and divides the emergency cavity 11 into an emergency upper cavity 111 and an emergency lower cavity 112, and the transition hole 41 is arranged on the driving main body 42. By using the second valve cover 18, the advantages of easy processing and installation are achieved.

In this embodiment, the movement of the driving assembly 40 is facilitated by the elastic cap 43, the emergency cavity 11 is also divided, and the second valve core 32 can be driven by the driving main body 42 to move.

The driving main body 42 includes a driving cap and a driving rod which are connected to each other, the elastic cap 43 is arranged on the driving cap, the transition hole is arranged on the driving rod, and an end of the driving rod can drive the deflation valve assembly 50 to move.

Specifically, the valve body 10 further includes a third valve cover 19, and the pilot valve cavity 17 is arranged on the third valve cover 19. By using the third valve cover 19, the pilot valve assembly 60 can be arranged on the third valve cover 19, so that the advantages of easy processing and installation are achieved.

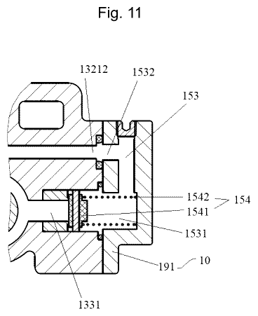

As shown in FIG. 1 and FIG. 11, the valve body 10 is further provided with an inflation passage 153, an air inlet of the inflation passage 153 is in communication with the air outlet of the non-return cavity 133, an air outlet of the inflation passage 153 is in communication with the air inlet of the first driving cavity 1321, a non-return valve 154 is arranged in the inflation passage 153, the non-return valve 154 includes a non-return valve core 1541 and a return spring 1542, one end of the return spring 1542 abuts against the non-return valve core 1541, and the other end of the return spring 1542 abuts against the valve body 10. By using the inflation passage 153, the advantage of easy communication between the inflation cavity 13 and the first driving cavity 1321 is achieved. By using the non-return valve 154, during the first inflation of the train, the pressurized air in the train pipe 71 can be prevented from being directly filled into the brake cylinder 72 through the first driving cavity 1321.

Specifically, the valve body 10 further includes a fourth valve cover 191 connected with the valve main body 15, the inflation passage 153 includes a first section, a second section and a third section which are in communication sequentially, the first section and the third section are arranged on the valve main body 15, and the second section is arranged on the fourth valve cover 191. By means of connection between the fourth valve cover 191 and the valve main body 15, the advantage of easy processing of the inflation passage 153 is achieved.

As shown in FIG. 1 and FIG. 2, both the first passage 141 and the second passage 142 have a strip-shaped structure, and the first passage 141 is perpendicular to the second passage 142. By using the first passage 141 and second passage 142 having the above structure, the advantage of easy processing is achieved. Moreover, by means of perpendicular arrangement, the lengths of the first passage 141 and the second passage 142 can be reduced.

The above descriptions are only preferred embodiments of the present disclosure, but are not intended to limit the present disclosure. It will be apparent to those skilled in the art that various modifications and changes can be made in the present disclosure. Any modifications, equivalent replacements, improvements, and the like made within the spirit and principle of the present disclosure shall be included within the protection scope of the present disclosure.

1. An emergency valve, wherein the emergency valve comprises:
a valve body comprising an emergency cavity, a pressure increasing cavity and an inflation cavity which are spaced apart from one another, wherein an extension direction of the pressure increasing cavity is the same as an extension direction of the inflation cavity, an air inlet of the emergency cavity is in communication with a train pipe, the pressure increasing cavity is provided with a first communication port, a second communication port and a relief port, the relief port of the pressure increasing cavity is located between the first communication port of the pressure increasing cavity and the second communication port of the pressure increasing cavity, the first communication port of the pressure increasing cavity is in communication with a brake cylinder, the second communication port of the pressure increasing cavity is in communication with the emergency cavity, the relief port of the pressure increasing cavity is in communication with an accelerated relief air cylinder, a valve sleeve is arranged in the inflation cavity, and an outer side wall of the valve sleeve is attached to a cavity wall of the inflation cavity and divides the inflation cavity into a driving cavity and a non-return cavity;
a pressure increasing valve core movably arranged in the pressure increasing cavity, wherein an outer side wall of the pressure increasing valve core is attached to an inner side wall of the pressure increasing cavity, the first communication port of the pressure increasing cavity and the second communication port of the pressure increasing cavity respectively correspond to both ends of the pressure increasing valve core, the pressure increasing valve core is provided with a vent hole, a first end of the vent hole is in communication with the first communication port of the pressure increasing cavity, a second end of the vent hole penetrates through a side wall of the pressure increasing valve core, the pressure increasing valve core has a communication position and a pressure maintaining position, when the pressure increasing valve core is located in the communication position, the second end of the vent hole is in communication with the relief port of the pressure increasing cavity, and when the pressure increasing valve core is located in the pressure maintaining position, the second end of the vent hole is isolated from the relief port of the pressure increasing cavity; and
an inflation valve core comprising a first valve core and a second valve core, wherein the first valve core is movably arranged in the driving cavity and divides the driving cavity into a first driving cavity and a second driving cavity, an air outlet of the first driving cavity is in communication with the emergency cavity, the second driving cavity is in communication with an emergency chamber, the second valve core is movably arranged at an air outlet of the non-return cavity, an air inlet of the non-return cavity is in communication with the brake cylinder, the air outlet of the non-return cavity is in communication with an air inlet of the first driving cavity, an end of the first valve core is movably arranged in the valve sleeve, and the first valve core has an inflation position for pushing the second valve core away from an air outlet of the inflation cavity and a blocking position for releasing the second valve core,
wherein the valve body is further provided with a communication passage, the second communication port of the pressure increasing cavity is in communication with the emergency cavity through the communication passage, and the air outlet of the first driving cavity is in communication with the emergency cavity through the communication passage.

2. The emergency valve according to claim 1, wherein the communication passage comprises a first passage and a second passage which are arranged in an intersected manner, an air inlet of the first passage is in communication with the emergency cavity, a first air outlet of the first passage is in communication with an air inlet of the second passage, a first air outlet of the second passage is in communication with the first driving cavity, and a second air outlet of the second passage is in communication with the second communication port of the pressure increasing cavity.

3. The emergency valve according to claim 2, wherein the pressure increasing cavity and the inflation cavity are respectively located on both sides of the emergency cavity, the second passage has a strip-shaped structure, the air inlet of the second passage is arranged in a middle of the second passage, and the first air outlet of the second passage and the second air outlet of the second passage are respectively arranged at both ends of the second passage.

4. The emergency valve according to claim 2, wherein the valve body comprises a valve main body and a first valve cover covered at an end of the valve main body, the emergency cavity, the pressure increasing cavity and the inflation cavity are all arranged on the valve main body, and the first passage and the second passage are both arranged on the first valve cover.

5. The emergency valve according to claim 4, wherein the valve body further comprises a relief passage, a first end of the relief passage is in communication with the relief port of the pressure increasing cavity, and a second end of the relief passage is in communication with the accelerated relief air cylinder;
the valve body further comprises an emergency passage, a first end of the emergency passage is in communication with the emergency chamber, and a second end of the emergency passage is in communication with the second driving cavity; and
the valve body further comprises an air inlet passage, a first end of the air inlet passage is in communication with the brake cylinder, and a second end of the air inlet passage is in communication with the air inlet of the non-return cavity,
wherein the second end of the relief passage, the first end of the emergency passage, the second end of the air inlet passage, the air inlet of the emergency cavity and the first communication port of the pressure increasing cavity are all arranged at an end of the valve main body away from the first valve cover.

6. The emergency valve according to claim 4, wherein the valve body further comprises a pilot valve cavity and a pilot valve passage, an air inlet of the pilot valve passage is in communication with a second air outlet of the first passage, an air outlet of the pilot valve passage is in communication with an air inlet end of the pilot valve cavity, the first passage has a strip-shaped structure, and the first air outlet of the first passage is arranged between the air inlet of the first passage and the second air outlet of the first passage.

7. The emergency valve according to claim 6, wherein
the emergency valve further comprises a driving assembly, the driving assembly is movably arranged in the emergency cavity, the driving assembly divides the emergency cavity into an emergency upper cavity and an emergency lower cavity, the driving assembly is provided with a transition hole, and the transition hole is in communication with the emergency upper cavity and the emergency lower cavity;
the emergency valve further comprises a deflation valve assembly, the deflation valve assembly is located in the emergency lower cavity, the driving assembly is located above the deflation valve assembly, a division plate is arranged in the emergency cavity, the division plate divides the emergency lower cavity into an air inlet cavity and an air discharge cavity located below the air inlet cavity, the division plate is provided with a deflation hole, and the deflation valve assembly is movably arranged at the deflation hole; and
the emergency valve further comprises a pilot valve assembly, the pilot valve assembly is arranged in the pilot valve cavity and isolates the pilot valve cavity from the air discharge cavity, the deflation valve assembly is located above the pilot valve assembly, and the pilot valve assembly is movably arranged at an air outlet end of the pilot valve cavity.

8. The emergency valve according to claim 7, wherein
the valve body further comprises a second valve cover, the second valve cover is covered above the driving assembly, the driving assembly comprises a driving main body and an elastic cap connected with the driving main body, the elastic cap is clamped between the valve main body and the second valve cover and divides the emergency cavity into an emergency upper cavity and an emergency lower cavity, and the transition hole is arranged on the driving main body; and/or
the valve body further comprises a third valve cover, and the pilot valve cavity is arranged on the third valve cover.

9. The emergency valve according to claim 7, wherein
the valve body is further provided with an inflation passage, an air inlet of the inflation passage is in communication with the air outlet of the non-return cavity, an air outlet of the inflation passage is in communication with the air inlet of the first driving cavity, a non-return valve is arranged in the inflation passage, the non-return valve comprises a non-return valve core and a return spring, an end of the return spring abuts against the non-return valve core, and the other end of the return spring abuts against the valve body; and
the valve body further comprises a fourth valve cover connected with the valve main body, the inflation passage comprises a first section, a second section and a third section which are in communication sequentially, the first section and the third section are arranged on the valve main body, and the second section is arranged on the fourth valve cover.

10. The emergency valve according to claim 2, wherein
both the first passage and the second passage have a strip-shaped structure, and the first passage is perpendicular to the second passage; and/or
the first valve core comprises a piston cap and a piston rod which are connected to each other, an outer edge of the piston cap is attached to a cavity wall of the driving cavity and divides the driving cavity into the first driving cavity and the second driving cavity, and an end of the piston rod is arranged corresponding to the second valve core.
